(19) United States
(12) Patent Application Publication
(10) Pub. No.: US 2026/0222306 A1
(43) Pub. Date: Jul. 30, 2026

(54) AGGREGATION OF DIFFERENT ANALYTICS FOR MULTI-LAYER NETWORK FUNCTIONS

(71) Applicant: Telefonaktiebolaget LM Ericsson (publ), Stockholm (SE)

(72) Inventors: Abdulrahman ALABBASI, Kista (SE); Antonio INIESTA GONZALEZ, Madrid (ES); Ulf MATTSSON, Kungsbacka (SE); Sabrine AROUA, Antony (FR); Hossein SHOKRI GHADIKOLAEI, Täby (SE)

(21) Appl. No.: 19/147,704

(22) PCT Filed: Jan. 13, 2023
(86) PCT No.: PCT/EP2023/050747

§ 371 Date: Jul. 13, 2025

(51) Int. Cl. H04L 41/14; H04L 41/16

(52) U.S. Cl. CPC H04L 41/145; H04L 41/16

(57) ABSTRACT

A computer-implemented method is provided that is performed by a computing device comprising a network data analytics function, NWDAF, to provide aggregated analytics from network functions in a communication network. The method includes aggregating different analytics from the network functions to obtain an aggregated analytics. The different analytics include at least one of a different hierarchical level in the network functions, and/or a different timescale, a different periodicity, a common input analytic, and a common output analytic in the different analytics. The method further includes obtaining a latent space of the different analytics with a first ML model applied to the aggregated analytics; and sending to at least a network function consumer at least one of the latent space and the different analytics. Related methods and apparatuses are also provided.

### TECHNICAL FIELD

The present disclosure relates generally to computer-implemented methods by a computing device including a network data analytics function (NWDAF) to provide aggregated analytics from a plurality of multi-layer network functions in a communication network, and related methods and apparatuses.

### BACKGROUND

Third Generation Partnership Project (3GPP) TS 23.288 v17.6.0 is directed to architecture enhancements for fifth generation (5G) system (5GS) to support network data analytics services in a 5G core (5GC) network. As discussed in TS 23.288 v17.6.0, the NWDAF is part of the architecture specified in TS 23.501 v17.6.0 and uses the mechanisms and interfaces specified for 5GC in TS 23.501 and operations administration and maintenance (OAM) services. The NWDAF interacts with different entities for different purposes, including, for example:
Data collection based on subscription to events provided by access and mobility management function (AMF), session management function (SMF), policy control function (PCF), unified data management (UDM), network slice access control function (NSACF), application function (AF) (directly or via network exposure function (NEF)) and OAM;
Optionally, analytics and data collection using the Data Collection Coordination Function (DCCF);
Retrieval of information from data repositories (e.g., unified data repository (UDR) via UDM for subscriber-related information;
Optionally, storage and retrieval of information from Analytics Data Repository Function (ADRF);
Optionally, analytics and data collection from Messaging Framework Adaptor Function (MFAF);
Retrieval of information about NFs (e.g., from network repository function (NRF) for network function (NF)-related information);
On demand provision of analytics to consumers, as specified in clause 6 of TS 23.288 v17.6.0.
Provision of bulked data related to analytics ID(s).

As further discussed in TS 23.288 v17.6.0, a single instance or multiple instances of NWDAF may be deployed in a public land mobile network (PLMN). If multiple NWDAF instances are deployed, the architecture supports deploying the NWDAF as a central NF, as a collection of distributed NFs, or as a combination of both. If multiple NWDAF instances are deployed, an NWDAF can act as an aggregate point (e.g., Aggregator NWDAF) and collect analytics information from other NWDAFs, which may have different serving areas, to produce the aggregated analytics (per Analytics ID), possibly with analytics generated by itself. It is noted that when multiple NWDAFs exist, not all of them need to be able to provide the same type of analytics results, e.g., some of them can be specialized in providing certain types of analytics. An Analytics ID information element is used to identify the type of supported analytics that NWDAF can generate. It is further noted that NWDAF instance(s) can be collocated with a 5GS NF.

3GPP TS 23.288 v17.6.0 also describes the following considerations.

Multiple aggregation levels of NWDAF analytics, e.g., for a certain area of interest or just a service aggregation. Different scenarios can occur under this consideration, such as a network function (NF) may request an analytic from a specific or different aggregation level.

Multiple time granularity levels use-cases addressed by NWDAF analytics, e.g., service experience, device behavior, network condition, etc. related use-case(s) analytics, which can represent high, medium, and low (or real-time) granular time levels. Multiple NFs at different time-granularity scales may request single or multiple analytics with a different timescale (or time granularity). For example, in 3GPP TS 28.550 v18.0.0, when an entity request measurement related to a key performance indicator (KPI) or management service (MnS) from OAM has to be associated with a granularityPeriod because it is used to create a measurement job(s).

Commonality can be observed among input of different analytics. Table 1 below illustrates an example of analytics with some input/output commonalities:

| A1: Network Slice Instance (NSI) Load Level | | | |
|---|---|---|---|
| Computation Analytics | | A4: User Equipment (UE) Mobility Analytics | |
| Input | Output | Input | Output |
| 1. Number of UEs | 1. NSI | 1. UE (ID/Location/ | 1. UE/ |
| registered in NSI, access | | Time stamp) | group ID |
| and mobility management | | | |
| function (AMF), & network | | | |
| slice (NwSlice) | | | |
| 2. Packet data unit (PDU) | 2. No. of UEs | 2. AMF frequent | 2. Timeslot/ |
| sessions established | | mobility pattern | duration |
| 3. Load of NFs associated | 3. Resource usage | 3. Access behavior | 3. UE location and |
| with NSI | (computation) | trend | trajectory |
| 4. Resource utilization of | 4. No. of PDU sessions | 4. UE trajectory of | |
| info. of NSI | | location/mobility | |
| | | 5. Application ID | |
| A2: NF Load Analytics | | A5: UE Communication Analytics | |
| Input | Output | Input | Output |
| 1. Load of NFs | 1. NF type/ | 1. Number of UEs | 1. UE ID/group |
| | ID/status | (ID/group/application | |
| | | ID) | |
| 2. NF status | 2. NF resource usage | 2. NSSAI | 2. UE communication |
| | | | time/period |
| 3. NF resource usage | 3. NF load | 3. UE behavior | 3. Traffic |
| | (peak/average/per area) | | characteristics, |
| | | | volume, & uplink |
| | | | (UL)/downlink (DL) |
| | | | rates |
| 4. NF configuration | | 4. UL/DL data rate & | 4. Application ID & |
| | | traffic volume | information |
| | | 5. UE location and | 5. N4 sessions |
| | | trajectory (trends) | |
| | | 6. PDU sessions | |
| | | 7. UE access and | |
| | | communication | |
| | | behavior | |
| | | A6: Expected UE Behavioral Parameters | |
| A3: Network Performance Analytics | | Related Network Data Analytics | |
| Input | Output | Input | Output |
| 1. No. of UEs registered in | 1. Area of interest, and | 1. UE mobility and | 1. UE mobility and |
| area of interest | time window of interest | location trends | location trends |
| 2. Radio resource utilization | 2. gNodeB (gNB) | 2. UE communication | 2. UE communication |
| | information (resource | trends information | trends information |
| | usage and statue) | | |
| 3. Radio access network | 3. No. of UEs in target | | |
| (RAN) status, per cell and | of interest | | |
| per area | | | |
| 4. Load of NFs | 4. Mobility performance | | |
| | 5. Communication | | |
| | performance (success | | |
| | rate) | | |

Table 1 above shows a non-limiting example of six groups of analytics (A1-A6). As shown in Table 1, Group A1 includes NSI Load Level Computation Analytics having four inputs and four outputs; Group A2 includes NF Load Analytics having four inputs and three outputs; Group 3 includes Network Performance Analytics having four inputs and five outputs; Group A4 includes UE Mobility Analytics having five inputs and three outputs; Group A5 includes UE Communication Analytics having seven inputs and five outputs; and group A6 includes Expected UE Behavioral Parameters Related Network Data Analytics having two inputs and two outputs. As illustrated in Table 1, commonality can be observed among some inputs of the different groups of analytics. For example,
Groups A1 and A2 have a common input, load of NFs;
Groups A1 and A3 have three common inputs: Number of UEs registered; radio resource utilization; and load of NFs;
Groups A4 and A5 have three common inputs: UE (ID/location/time stamp); US trajectory of location/mobility, and access behavior;
Groups A4 and A6 have one common input: UE trajectory of location/mobility
Groups A1 and A4 have one common input: number of UEs

It may be desirable for interaction of corresponding output of such analytics to be optimized to, e.g., (1) reduce interaction footprint on the network, (2) de-noise analytics, and/or (3) enrich analytics with features that can improve NF predictions and decision.

### SUMMARY

Certain aspects of the disclosure and their embodiments may provide solutions to these or other challenges.

Some embodiments of the present disclosure, provide a computer-implements method performed by a computing device including a network data analytics function, NWDAF, to provide aggregated analytics from a plurality of network functions in a communication network. The method includes aggregating a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The method further includes obtaining a latent space of the plurality of different analytics with a first machine learning, ML, model applied to the aggregated analytics. The method further includes sending to at least a network function consumer at least one of the latent space and the plurality of different analytics.

Other embodiments provide a computer-implemented method performed by a computing device including a NWDAF to provide aggregated analytics from a plurality of network functions in a communication network. The method includes clustering a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The method further includes identifying an interface to relay the at least one of a value and a policy to a network function consumer including a network function of a higher layer or a lower layer.

In other embodiments, a computing device configured to provide aggregated analytics from a plurality of network functions in a communication network is provided. The computing device includes processing circuitry; and memory coupled with the processing circuitry. The memory includes instructions that when executed by the processing circuitry causes the computing device to perform operations. The operations include to aggregate a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to obtain a latent space of the plurality of different analytics with a first ML model applied to the aggregated analytics. The operations further include to send to at least a network function consumer at least one of the latent space and the plurality of different analytics.

In other embodiments, a computing device configured to provide aggregated analytics from a plurality of network functions in a communication network, is provided. The computing device is adapted to perform operations. The operations include to aggregate a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to obtain a latent space of the plurality of different analytics with a first ML model applied to the aggregated analytics. The operations further include to send to at least a network function consumer at least one of the latent space and the plurality of different analytics.

In other embodiments, a computer program comprising program code to be executed by processing circuitry of a computing device configured to provide aggregated analytics from a plurality of network functions in a communication network is provided. Execution of the program code causes the computing device to perform operations. The operations include to aggregate a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to obtain a latent space of the plurality of different analytics with a first ML model applied to the aggregated analytics. The operations further include to send to at least a network function consumer at least one of the latent space and the plurality of different analytics.

In other embodiments, a computer program product comprising a non-transitory storage medium including program code to be executed by processing circuitry of a computing device is provided. Execution of the program code causes the computing device to perform operations. The operations include to aggregate a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to obtain a latent space of the plurality of different analytics with a first ML model applied to the aggregated analytics. The operations further include to send to at least a network function consumer at least one of the latent space and the plurality of different analytics.

In other embodiments, a computing device configured to provide aggregated analytics from a plurality of network functions in a communication network is provided. The computing device includes processing circuitry; and memory coupled with the processing circuitry. The memory includes instructions that when executed by the processing circuitry causes the computing device to perform operations. The operations include to cluster a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to identify an interface to relay the at least one of a value and a policy to a network function consumer including a network function of a higher layer or a lower layer.

In other embodiments, a computing device configured to provide aggregated analytics from a plurality of network functions in a communication network is provided. The computing device is adapted to perform operations. The operations include to cluster a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to identify an interface to relay the at least one of a value and a policy to a network function consumer including a network function of a higher layer or a lower layer.

In other embodiments, a computer program comprising program code to be executed by processing circuitry of a computing device configured to provide aggregated analytics from a plurality of network functions in a communication network is provided. Execution of the program code causes the computing device to perform operations. The operations include to cluster a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to identify an interface to relay the at least one of a value and a policy to a network function consumer including a network function of a higher layer or a lower layer.

In other embodiments, a computer program product comprising a non-transitory storage medium including program code to be executed by processing circuitry of a computing device is provided. Execution of the program code causes the computing device to perform operations. The operations include to cluster a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The operations further include to identify an interface to relay the at least one of a value and a policy to a network function consumer including a network function of a higher layer or a lower layer.

Certain embodiments may provide one or more of the following technical advantages. Based on inclusion of aggregation of different analytics for multilayer NFs and a ML model applied to the aggregated analytics, utilizing and accommodating requests for different aggregation level analytics in an efficient manner may be achieved. Additionally, efficient information exchange per a group of analytics for a group of subscribed NF consumers with the same efficiency of the conveyed analytics (e.g., efficiency in terms of an optimal decision made at NF consumers) may be achieved. Further technical advantages may include creating an association with local/specific properties; and/or monetization of NWDAF analytics that may allow more technical advances in network vendor proprietary solutions provided to external parties.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating an example framework of a NWDAF in accordance with some embodiments.

FIG. 2 is a block diagram illustrating an example of the NWDAF of FIG. 1 and the example analytics of Table 1 for groups of subscribed NF consumers for standardized and/or proprietary solutions of hierarchical NFs, in accordance with some embodiments.

FIG. 3 is a block diagram of an example of a NWDAF implementation that includes an autoencoder in accordance with some embodiments.

FIG. 4 is a sequence diagram illustrating an example of three sets of operations in accordance with some embodiments.

FIG. 5 is a block diagram illustrating an example of a value function/policy to support a hierarchical reinforcement learning (RL) architecture in accordance with some embodiments.

FIG. 6 is a flow chart illustrating operations of a computing device according to some embodiments of the present disclosure.

FIG. 7 is a flow chart illustrating operations of a computing device according to some embodiments of the present disclosure.

FIG. 8 is a block diagram of a communication network in accordance with some embodiments.

FIG. 9 is a block diagram of a network function consumer in accordance with some embodiments.

FIG. 10 is a block diagram of a computing device in accordance with some embodiments.

FIG. 11 is a block diagram of a virtualization environment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Potential problems exist in order to address considerations discussed above related to (1) multiple aggregation levels, (2) different time granularities, and (3) common inputs of different requested analytics via different NFs. For example, complicated models and data collection algorithms may need to be implemented to accommodate a per individual request of all of the NFs. However, such an implementation may not be scalable, for example, with growth of NFs and deployment and heterogeneity of services.

Certain aspects of the disclosure and their embodiments may provide solutions to these or other challenges. Some embodiments include a collective/aggregated way of expressing an analytic to a group of NFs in different levels.

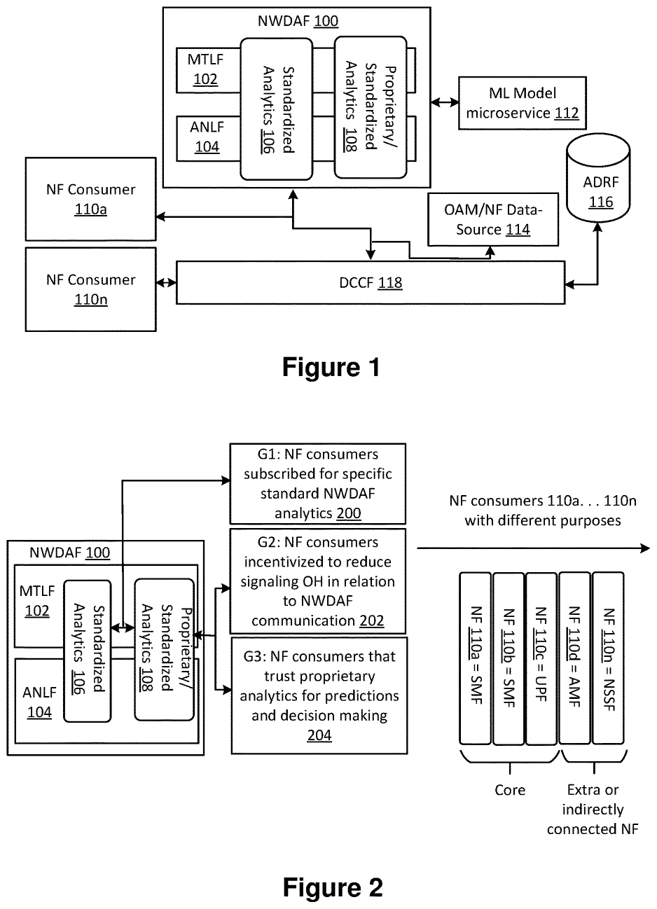

For ease of discussion, example embodiments of the present disclosure are explained herein in the non-limiting context of FIGS. 1-5. The example embodiments of FIGS. 1-5 include a discussion of example analytics included in Table 1. The present disclosure is not so limited, however, and can be applied to other analytics and NFs of a communication network.

FIG. 1 is a block diagram illustrating an example framework of a NWDAF in accordance with some embodiments. FIG. 2 is a block diagram illustrating an example of the NWDAF of FIG. 1 and the example analytics of Table 1 for groups of subscribed NF consumers for several standardized and/or proprietary solutions of hierarchical NFs, in accordance with some embodiments.

FIG. 1 includes NWDAF 100, which includes model training logical function (MTLF) 102 and ANLF 104. MTLF 102 can be a logical function which trains machine learning (ML) models and exposes new training services (e.g., providing a trained ML model). ANLF 104 can be a logical function which performs inference, derives analytics information (e.g., derives statistics and/or predictions based on an analytics consumer request), and exposes analytics service (e.g., Nnwdaf_AnalyticsSubscription or Nnwdaf_AnalyticsInfo). MTLF 102 and ANLF 104 can include proprietary analytics (e.g., of a provider for ML model/inference/training) and/or standardized analytics 108 (e.g., analytics standardized in 3GPP for ML model/inference training). FIG. 1 further includes one or more NF consumers 110a-110n (any one of which is referred to herein as a “NF consumer 110”), which is communicatively coupled to NWDAF 100 and DCCF 118. DCCF 118 is also communicatively coupled to OAM/NF data source 114 and ADRF 116. ML model microservice 112 is communicatively coupled with NWDAF 100,

Referring to the example of FIG. 2, three types of NF consumers 110a . . . 110n are included. A first type is group 1 (G1) 200 which represents NF consumers subscribed for specific standard-based NWDAF analytics 106 (e.g., standard-based analytics of TS 23.288 v17.6.0), some of which analytics are represented in Table 1. A second type in the example of FIG. 2 is group 2 (G2) 202, which represents NF consumers that have an incentive to reduce signaling overhead in relation to NWDAF communication using proprietary/standardized analytics 108; and a third type is group 3 (G3) 204, which represents network vendor NF consumers (e.g., local or external) who trust such vendor proprietary analytics 108 to improve the G3 NF consumers in their respective predictions and decision-making. Embodiments of the present disclosure are directed to proprietary/standardized analytics 108, such as type G2 and G3 analytics, for example.

In the example of FIG. 2, selected analytics (SA1) from proprietary/standardized analytics 108 represents a combination of analytics, such as A1, A3/4, A5, A6 from the example of Table 1. The example selected analytics SA1 can be used to enable mobility management, communication measurement related operation, and network slicing resource scheduling within different NF consumers 110a . . . 110n having different purposes with a different periodicity P1/2 and a different timescale T1/2. For example, SA1 for different NF consumers 110a . . . 110n, such as analytics group A1 for a PCF, a network slice selection function (NSSF), a AMF; analytics group A3 for a PCF, a NEF, an AF, an OAM; analytics group A4/5 for a AMF, a SMF or a AF) However, some of the analytics in groups A1, A3, A5, A6 of Table 1 have some common inputs (as discussed above), and they also are used at different levels of network functions (e.g., NF consumer 110a can be a core SMF; NF consumer 110b can be a core SMF; NF consumer 11c can be a core UPF; extra/indirectly connected NF consumer 110d can be a AMF; and extra/indirectly connected NF consumer 110n can be a NSSF; or the output of such core NF consumers can be indirectly used for other segments of network transport and/or a RAN. Additionally, such core NF consumers' usage of those analytics can be different in timescale and periodicity, depending on the service that they provide to either the core, transport or RAN.

Moreover, further potential problems may include that some currently unresolved considerations and assumptions on a NWDAF in existing standardization, such as TS 23.288 v17.6.0, including without limitation the following examples:

1. Whether a NWDAF is allowed to make a decision or recommendation to help a NF (e.g., act as an analytical brain for the NFs) or not, may be undecided in a standard. One view may be to not allow the NWADF to make a suggestion or recommendation for an action; while another view may be that the NWDAF can send a recommendation and decision to a NF.

2. Whether a NF can send its actions to a NWDAF or not may be undecided in a standard. One view may be that a NF's actions can be openly sent to the NWDAF. Another view may be that only contextual information about an action(s) can be sent by a NF to the NWDAF. Such contextual information may be, e.g., (1) action ID, (2) whether a change was made on this action, and/or (3) what are the inputs used to make such a decision. Yet another view may be that nothing related to a NF's action can be sent out to a NWDAF.

3. Multiple NF consumers may request different analytics on a common time point, or may request different analytics for a similar time horizon, but with a common input(s). Other, similar scenarios also may exist, such inputs of the analytics are statistically correlated in time, e.g., a target time horizon may be the same; and/or NF consumer requests (or targeted time horizon) may occur for similar times.

Some embodiments of the present disclosure may address such potential problems and uncertainties, as discussed further herein.

Some embodiments include an operation that aggregates input and/or output of analytics at a NWDAF aggregation logical function (LF), analytical data repository function (ADRF), or an analytical logical function (AnLF) via auto-encoding or a hierarchical value and policy network.

As discussed further herein, operations are provided to handle efficient aggregation of multiple analytics requested from NF consumers. Some embodiments include sending a latent space to a NF consumer instead of analytics, which may provide a technical advantage of saving overhead and reducing complexity. Other embodiments include operations that may provide a technical advantage of reducing stored data (e.g., on an ADRF).

Further, based on aggregating different analytics that include at least one of a different hierarchical level in a plurality of network functions, and/or a different timescale, a different periodicity, a common input analytic, and a common output analytic, some embodiments may provide technical advantages including enabling multiple data aggregation levels with efficient distribution and transmission; enabling efficient storage of data; and/or reducing congestion.

Operations are provided to apply different aggregating artificial intelligence (A1) tools, such as value aggregation and/or latent aggregation, in order to address existing limitations on aggregating (e.g., such as aggregation lacking multiple aggregation levels in an interest area, different time-granularity, etc.).

Some embodiments are directed to a computer-implemented method performed by a computing device comprising a NWDAF is provided to provide aggregated analytics from a plurality of network functions in a communication network.

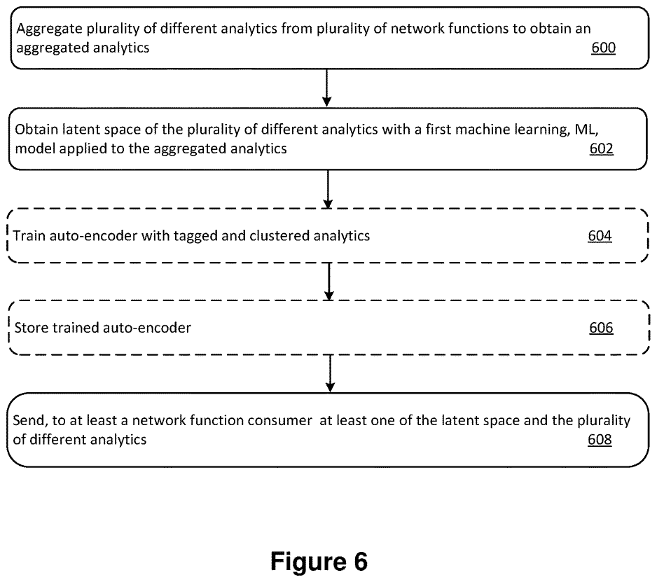

As illustrated in FIG. 6, the computer-implemented method includes aggregating (600) a plurality of different analytics from the plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The method further includes obtaining (602) a latent space of the plurality of different analytics with a first machine learning (ML) model applied to the aggregated analytics. The method further includes sending (608) to at least a network function consumer at least one of the latent space and the plurality of different analytics.

Some operations include split learning using an auto-encoder (AE) across multiple NWDAFs and NF nodes. For example, in some embodiments, the ML model includes an auto-encoder. Such embodiments, for example, may address the three problems regarding aggregation discussed herein regarding considerations and assumptions on an NWDAF related to existing standardization.

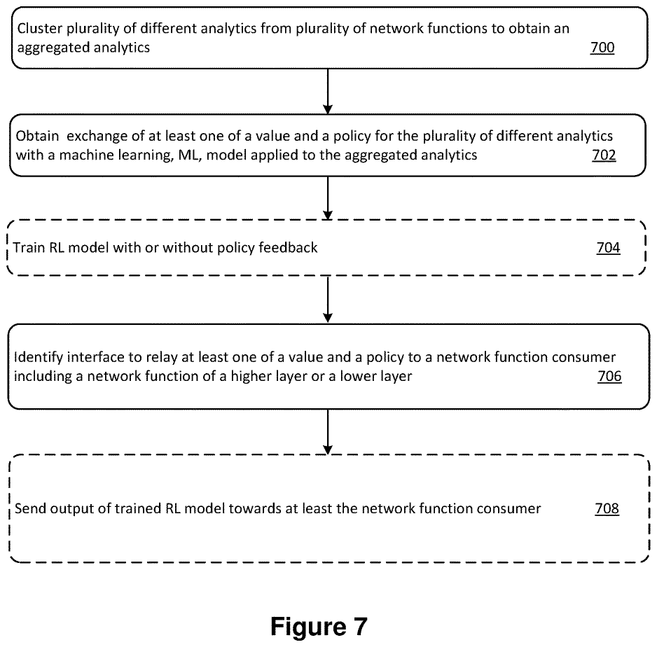

In some embodiments, as illustrated in FIG. 7, a computer implemented method performed by a computing device including a NWDAF is provided to provide aggregated analytics from a plurality of NFs in a communication network. The method includes clustering (700) a plurality of different analytics from a plurality of network functions to obtain an aggregated analytics. The plurality of different analytics include at least one of a different hierarchical level in the plurality of network functions, and/or a different timescale, a different periodicity, a common input analytic, and a common output analytic in the plurality of different analytics. The method further includes obtaining (702) an exchange of at least one of a value and a policy for the plurality of different analytics with a ML model applied to the aggregated analytics. The method further includes identifying (706) an interface to relay the at least one of a value and a policy to a second computing device including a network function of a higher layer or a lower layer.

Some operations include hierarchical reinforcement learning (RL) with value and policy functions across multiple NWDAF and NFs nodes. For example, in some embodiments of the method, the ML model includes a hierarchical RL model including a value function or a policy.

Operations of split learning using an auto-encoder are now discussed further, including example embodiments with reference to FIG. 6.

Some operations use an auto-encoder for communication (e.g., efficient communication) across entities, such as an NWDAF and NF consumers. In some operations, a NF consumer(s) receives a latent space of specific selected analytics (LSA) and a corresponding decoder to decode the needed analytics. For example, in some embodiments, the obtaining (602) includes an output layer of an encoder of the auto-encoder including the latent space of the plurality of different analytics and the output layer is connected to a plurality of network function consumers, and the sending (608) further includes sending a decoder to a respective network function consumer from the plurality of network function consumers to decode the latent space of the plurality of different analytics.

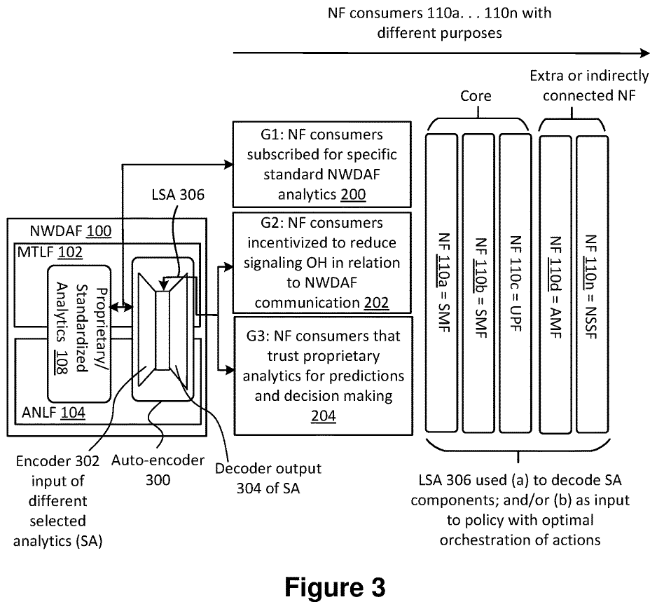

FIG. 3 is a block diagram of an example of a NWDAF 100 implementation that includes autoencoder 300. Autoencoder 300 includes an encoder 302 that receives input of different selected analytics (SA) 108 (e.g., selected analytics from groups A1, A2, A3, A4, A5, and A6 from Table 1). Network function (NF) consumers 110a . . . 110n in groups G2 and/or G3 having different purposes receive either (1) LSA 306 and a corresponding decoder 304 to decode the analytics in a first set of operations; (2) LSA 306 and they respectively use LSA 306 in their own respective decision making agent in a second set of operations; or (3) auto-encoder 3020 in a third set of operations, can enable storage, e.g., higher storage efficiency in a ADRF (e.g., ADRF 116).

NF consumers 110a . . . 110n of FIG. 3 include:
NF consumer 110a (e.g., in an SMF) requests from a NWDAF/NF selected analytics (SA) from groups A1, A3 and A5 (illustrated in Table1) with a periodicity P1 and a time scale T1.
NF consumer 110b (e.g., in an SMF) requests from the NWDAF/NF the SA from groups A1, A3, and A5 with a periodicity P2 and a time scale T2.
NF consumer 110c (e.g., in a UPF) requests from the NWDAF/NF the SA from groups A1, A3, and A5 with a periodicity P3 and a time scale T3.
NF consumer 110d (e.g., in an AMF) requests from the NWDAF/NF the SA from groups A1, A3, and A5 with a periodicity P4 and a time scale T4.
NF consumer 110n (e.g., in a NSSF) requests from the NWDAF/NF the SA from groups A1, A3, and A5 with a periodicity P5 and a time scale T5.

While five NF consumers are shown in example embodiments herein, the present disclosure is not so limited and may include any non-zero number of NF consumers.

In one of the first, second, or third set of operations, LSA 306 received by NF consumers 1110a . . . 220n is used (a) to decode the SA components, or (b) as input to policy for orchestration of action(s) (e.g., optimal orchestration).

In the first set of operations, NF consumers 110a . . . 110n in group G2 and/or G3 receive LSA 306 and a corresponding decoder 304 to decode the analytics. For example, the output LSA 306 of a bottleneck layer from the encoder 302 of the auto-encoder is connected to NF consumers 110a . . . 110n in groups G2 and G3. Thus, in the first set of operations, NF consumers 110a . . . 110n receive LSA 306 and decoder 304, and NF consumers 1110a . . . 110n can decode the SA components A1, A3. Each NF consumer 110a . . . 110n may receive a different decoder, or the same decoder.

In the second set of operations, NF consumers 110a . . . 110n receive LSA 306 and use LSA 306 in their own respective decision making agent, e.g., without a need to decode the original analytics. For example, in some embodiments, the obtaining (602) includes an output layer of an encoder of the auto-encoder including the latent space of the plurality of different analytics and the output layer is connected to a plurality of network function consumers, and the sending (608) includes sending the latent space of the plurality of different analytics to a respective network function consumer from the plurality of network function consumers to use as an input to a second ML model of the network function consumer to make a decision at the network function consumer.

In the second set of operations, as illustrated in the example of FIG. 3, NF consumers 110a . . . 110n can use LSA 306 as input to policy of the respective NF consumers 110a . . . 110n to identify an action or a make a decision (e.g., an optimal action or decision-making). In such operations, the NF consumer 110a . . . 110n can use the LSA 306 as input to its ML model(s) to produce a decision and, as a consequence, overhead savings may be achieved. It is noted that in such operations, the NF consumer 110 may not care about a specific analytic, but rather about the information embedded in the analytic. LSA 306 can be distributed frequently to a NF consumer(s). Decoder 304 can be distributed at an initialization phase or at another time (e.g., at completion of training of auto-encoder 300).

In FIG. 3, in operations where a NF consumers 110a . . . 110n receive LSA 306 and use LSA 306 in its own decision making agent, the NF consumers 110a . . . 110n can use a similar abstraction of the SA including A1, A3, and A5 analytics for its respective actuation purpose.

In the third set of operations, the auto-encoder 300 can enable storage, e.g., higher storage efficiency in a ADRF (e.g., ADRF 116). In an example embodiment, the obtaining (602) includes storing an output layer of an encoder of the auto-encoder including the latent space of the plurality of different analytics, and accessing a decoder stored at the NWDAF of the computing device, and decoding the latent space of the plurality of different analytics, and the sending (608) includes sending the decoded plurality of different analytics to a network function consumer.

In the example of FIG. 3, when the auto-encoder 300 is used to enable storage, the encoder 302 can be used on all input data of SA 108. Instead of storing features of analytic models at an ADRF, for example, LSA 306 output of the encoder 302 can be stored (e.g., at an ADRF). The storage can occur, for example, in an inference or training phase. Decoder 304 can be placed at an AnLF (e.g., AnLF 104) to provide analytic decoding and provide the analytic decoding to a NF consumer 110.

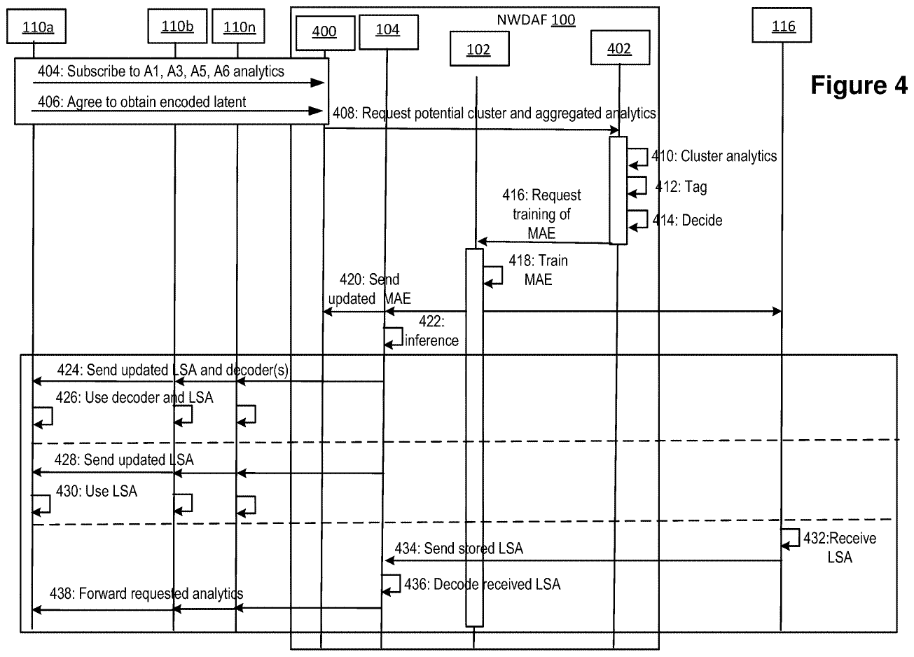

FIG. 4 is a sequence diagram illustrating an example of the three sets of operations discussed above. FIG. 4 includes NF consumers 110a, 110n . . . 110n; NWDAF 100, which includes a NWDAF 400, ANLF 104, MTLF 102, and NWDAF aggregation logical function (NALF) 402; and ADRF 116. In operation 404, NF consumers 110a . . . 110n (e.g., an SMF, UPF, and/or AMF) subscribe to A1, A3, A5, A6 analytics illustrated in Table 1.

NF consumers 110a . . . 110n (e.g., an SMF, UPF, and/or AMF), in operation 406, agree with NWDAF 400 to obtained encoded latent space analytics.

In operation 408, NWDAF 400 requests potential clustered and aggregated analytics from NALF 402.

NALF 402, in operation 410, applies clustering on the analytics based on (a) a number of common inputs, (b) a common area of interest; (c) a similarity of output; and (d) a similarity of time granularity. Alternatively, for example, the analytics may be conditioned on a time segment (e.g., point in time and periodicity) of a latent encoder model).

In operation 412, NALF 402 tags the corresponding analytics via a suitable for aggregation analytics (SAA).

NALF 402, in operation 414, decides on input/output and a parameter(s) of the auto-encoder 300 that may enhance the reconstruction error of the auto-encoder 300. Auto-encoder 300 parameters can include, e.g., bottle-neck layers, input as input of all requested analytics, and selected output of requested analytics, etc. that can lead to a high reconstruction ratio.

In an example embodiment, the aggregating (600) includes (i) applying clustering on the plurality of different analytics, (ii) tagging the clustered analytics via a suitable for aggregation analysis, and (iii) deciding on at least one of an input and an output parameter of the auto-encoder to enhance a reconstruction error.

In operation 416, NALF 402 requests MTLF 102 to train auto-encoder 300 with the specific analytic output as tagged in operation 412 via the SAA.

In operation 418, MTLF 102 trains auto-encoder 300 on two-dimensions (2D) or including temporal dimension. Training is done on both (a) encoder 302 using all inputs of aggregated analytic inputs, and (b) decoder 304 output including a common output of aggregated analytics, e.g., NF consumers 110a . . . 110n have their own respective output of the decoder 304. Decoder 304 can be split into three decoders, for example, where each decoder corresponds to one NF consumer 110.

In an example embodiment, the computer-implement method further includes training (604) the auto-encoder with the tagged and clustered analytics. The training includes (i) training the encoder using the tagged and clustered analytics, and (ii) training a decoder of the auto-encoder on a common output of the tagged and clustered analytics.

MTLF 102, in operation 420, sends the updated auto-encoder 300 (including encoder 304 and decoder 308) model to NWDAF 400, AnLF 104, and ADRF 116 for inference and storage of analytics related data. In an example embodiment, the computer-implement method further includes storing (606) the trained auto-encoder.

In an example embodiment, the obtaining (602) the latent space comprises (i) inputting the plurality of different analytics to an encoder of the auto-encoder, and (ii) outputting from the auto-encoder the latent space of the plurality of different analytics.

For the first set of operations discussed above, in operation 422, ANLF 104 performs inference on auto-encoder 300, to produce LSA 306 from encoder 302 and produce analytics from the decoder 304 to be sent to other LSA-non-registered NF consumers. In operation 424, ANLF 104 sends LSA 306 and decoder(s) 304 of auto-encoder 300 to NF consumers 110a . . . 110n. In operation 426, NF consumers 110a . . . 110n use decoder 304 and LSA 306 to obtain the requested analytics.

For the second set of operations discussed above, in operation 422, ANLF 104 performs inference on auto-encoder 300, to produce LSA 306 from encoder 302 to be sent to other LSA-non-registered NF consumers. In operation 428, ANLF 104 sends LSA 306 of auto-encoder 300 to NF consumers 110a . . . 110n. In operation 430, NF consumers 110a . . . 110n use LSA 306 in its own decision making agent, The NF consumer(s) 110a . . . 110n can use LSA 306 as input to policy of the NF consumer(s) 110a . . . 110n to identify an action or a make a decision (e.g., an optimal action or decision-making).

For the third set of operations discussed above, in operation 432, ADRF 116 applies encoder 302 of auto-encoder 300 inference to generate LSA 306 and stores the data; or, in operation 434, ADRF 116 sends the stored LSA 306 of the selected analytics AnLF 104 for decoding. In operation 436, AnLF 104 decodes the LSA 306 received from ADRF 116. In operation 438, AnLF 104 forwards the requested analytics to NF consumers 110a . . . 110n.

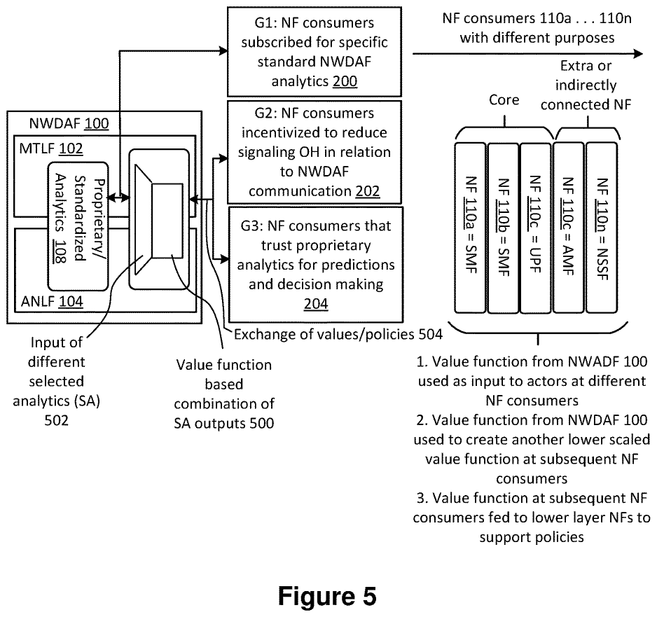

A value function can be used (or policies, e.g., if a standard allows) to support a hierarchical reinforcement learning (RL) architecture as shown in the example of FIG. 5. As illustrated, a RL model (e.g., a VNN) receives as input different selected analytics 502. An output of a value function (e.g., VNN) 500 based on a combination of SA outputs is connected to NF consumers 110a . . . 110n in G2 200 and G3 204. Value function 500 can be used in NF consumers 110a . . . 110n, without limitation, (1) as input to actors at the different NF consumers; (2) the value function can be used to create another lower scaled value function at subsequent NFs; and/or (3) the value function subsequent NF consumer can be fed to lower layer NFs to support policies.

Policies also may be exchanged or context of policies from subsequent NFs upward to the NWDAF.

As a consequence, NF consumers 110a . . . 110n can use a similar value abstraction of group A1, A3, A5 analytics from Table 1 for their respective actuation purpose.

Operations can include to (1) collect NF consumers' interest in different analytics, e.g., having different time granularities; (2) cluster a group of NF consumers that may benefit from (a) multiple analytics, (b) multiple time granularity predictions, (c) a single policy outcome, (d) a multiple policy outcome, and/or (e) low level and high level policies; (3) train a value function (a) with policy feedback (e.g., based on specifying an interface), and/or (b) without policy feedback; and (4) specify an interface to relay the value function from the NWDAF 100 to higher-layer and to lower-layer NF consumers 110a . . . 110n.

Some embodiments are directed to a computer-implemented method performed by a computing device comprising a NWDAF is provided to provide aggregated analytics from a plurality of network functions in a communication network.

As illustrated in FIG. 7, the computer-implemented method includes clustering (700) a plurality of different analytics from the plurality of network functions to obtain an aggregated analytics, the plurality of different analytics comprising at least one of a different hierarchical level in the plurality of network functions, and/or a different timescale, a different periodicity, a common input analytic, and a common output analytic in the plurality of different analytics. The method further includes obtaining (702) an exchange of at least one of a value and a policy for the plurality of different analytics with a ML model applied to the aggregated analytics. The method further includes identifying (706) an interface to relay the at least one of a value and a policy to a NF consumer including a network function of a higher layer or a lower layer.

The ML model can include a hierarchical RL model including a value function or a policy.

The plurality of different analytics can be an input to the RL model and an output of the RL model can include a value function-based combination or a policy of the plurality of different analytics.

In some embodiments, the method further includes training (704) the RL model with or without policy feedback; and sending (708) the output of the trained RL model towards at least the NF consumer.

The output of the RL model can be used at the plurality of different network functions to create a lower scaled value function or to support a policy.

Operations of a computing device can be performed by the computing device 10300 of FIG. 10. Operations of the computing device (implemented using the structure of FIG. 10) have been disclosed with reference to the flow charts of FIGS. 6 and 7 according to some embodiments of the present disclosure. For example, modules may be stored in memory 10304 of FIG. 10, and these modules may provide instructions so that when the instructions of a module are executed by respective computing device processing circuitry 10302, computing device 10300 performs respective operations of the flow charts.

Various operations from the flowcharts of FIGS. 6 and 7 may be optional with respect to some embodiments of computing devices and related methods. For example, the operations of blocks 640 and 606 of FIG. 6 and the operations of blocks 704 and 708 of FIG. 7 may be optional.

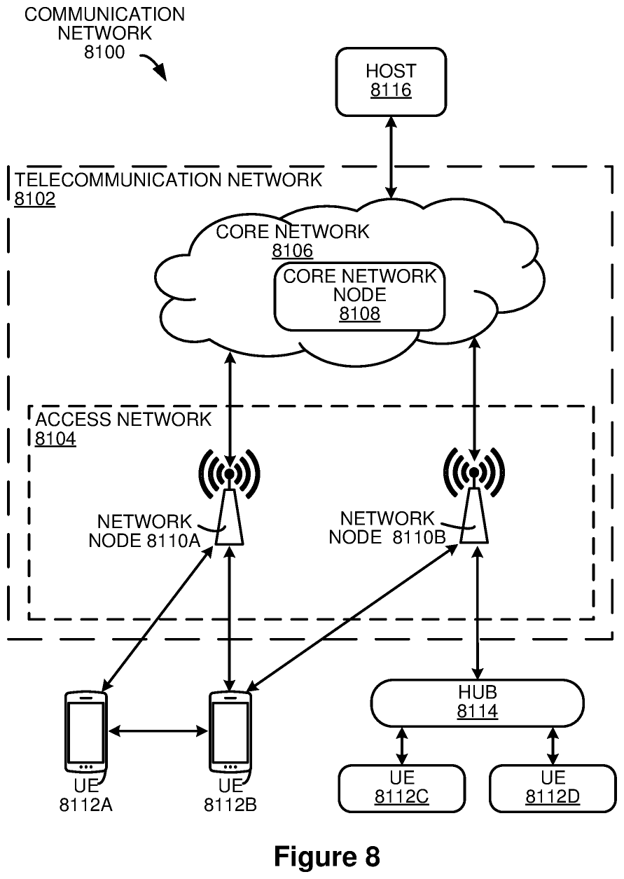

FIG. 8 shows an example of a communication network 8100 in accordance with some embodiments.

In the example, the communication network 8100 includes a telecommunication network 8102 that includes an access network 8104, such as a RAN, and a core network 8106, which includes one or more core network nodes 8108 (such as computing device 10300 discussed further herein). The access network 8104 includes one or more access network nodes, such as network nodes 8110a and 8110b (one or more of which may be generally referred to as network nodes 8110), or any other similar 3GPP access node or non-3GPP access point. The network nodes 8110 facilitate direct or indirect connection of user equipment (UE), such as by connecting UEs 8112a, 8112b, 8112c, and 8112d (one or more of which may be generally referred to as UEs 8112) to the core network 8106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication network 8100 may include any number of wired or wireless networks, network nodes, UEs, and/or any other components or systems that may facilitate or participate in the communication of data and/or signals whether via wired or wireless connections. The communication network 8100 may include and/or interface with any type of communication, telecommunication, data, cellular, radio network, and/or other similar type of system.

The UEs 8112 may be any of a wide variety of communication devices, including wireless devices arranged, configured, and/or operable to communicate wirelessly with the network nodes 8110 and other communication devices. Similarly, the network nodes 8110 are arranged, capable, configured, and/or operable to communicate directly or indirectly with the UEs 8112 and/or with other network nodes or equipment in the telecommunication network 8102 to enable and/or provide network access, such as wireless network access, and/or to perform other functions, such as administration in the telecommunication network 8102.

In the depicted example, the core network 8106 connects the network nodes 8110 to one or more hosts, such as host 8116. These connections may be direct or indirect via one or more intermediary networks or devices. In other examples, network nodes may be directly coupled to hosts. The core network 8106 includes one more core network nodes (e.g., core network node 8108) that are structured with hardware and software components. Features of these components may be substantially similar to those described with respect to the UEs, network nodes, and/or hosts, such that the descriptions thereof are generally applicable to the corresponding components of the core network node 8108. Example core network nodes include functions of one or more of a Mobile Switching Center (MSC), Mobility Management Entity (MME), Home Subscriber Server (HSS), AMF, SMF, Authentication Server Function (AUSF), Subscription Identifier De-concealing function (SIDF), UDM, Security Edge Protection Proxy (SEPP), NEF, and/or a User Plane Function (UPF).

The host 8116 may be under the ownership or control of a service provider other than an operator or provider of the access network 8104 and/or the telecommunication network 8102, and may be operated by the service provider or on behalf of the service provider. The host 8116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication network 8100 of FIG. 8 enables connectivity between the UEs, network nodes, and hosts. In that sense, the communication network may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 8102 is a cellular network that implements 3GPP standardized features. Accordingly, the telecommunications network 8102 may support network slicing to provide different logical networks to different devices that are connected to the telecommunication network 8102. For example, the telecommunications network 8102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 8112 are configured to transmit and/or receive information without direct human interaction. For instance, a UE may be designed to transmit information to the access network 8104 on a predetermined schedule, when triggered by an internal or external event, or in response to requests from the access network 8104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 8114 communicates with the access network 8104 to facilitate indirect communication between one or more UEs (e.g., UE 8112c and/or 8112d) and network nodes (e.g., network node 8110b). In some examples, the hub 8114 may be a controller, router, content source and analytics, or any of the other communication devices described herein regarding UEs. For example, the hub 8114 may be a broadband router enabling access to the core network 8106 for the UEs. As another example, the hub 8114 may be a controller that sends commands or instructions to one or more actuators in the UEs. Commands or instructions may be received from the UEs, network nodes 8110, or by executable code, script, process, or other instructions in the hub 8114. As another example, the hub 8114 may be a data collector that acts as temporary storage for UE data and, in some embodiments, may perform analysis or other processing of the data. As another example, the hub 8114 may be a content source. For example, for a UE that is a VR headset, display, loudspeaker or other media delivery device, the hub 8114 may retrieve VR assets, video, audio, or other media or data related to sensory information via a network node, which the hub 8114 then provides to the UE either directly, after performing local processing, and/or after adding additional local content. In still another example, the hub 8114 acts as a proxy server or orchestrator for the UEs, in particular if one or more of the UEs are low energy IoT devices.

The hub 8114 may have a constant/persistent or intermittent connection to the network node 8110b. The hub 8114 may also allow for a different communication scheme and/or schedule between the hub 8114 and UEs (e.g., UE 8112c and/or 8112d), and between the hub 8114 and the core network 8106. In other examples, the hub 8114 is connected to the core network 8106 and/or one or more UEs via a wired connection. Moreover, the hub 8114 may be configured to connect to an M2M service provider over the access network 8104 and/or to another UE over a direct connection. In some scenarios, UEs may establish a wireless connection with the network nodes 8110 while still connected via the hub 8114 via a wired or wireless connection. In some embodiments, the hub 8114 may be a dedicated hub—that is, a hub whose primary function is to route communications to/from the UEs from/to the network node 8110b. In other embodiments, the hub 8114 may be a non-dedicated hub—that is, a device which is capable of operating to route communications between the UEs and network node 8110b, but which is additionally capable of operating as a communication start and/or end point for certain data channels.

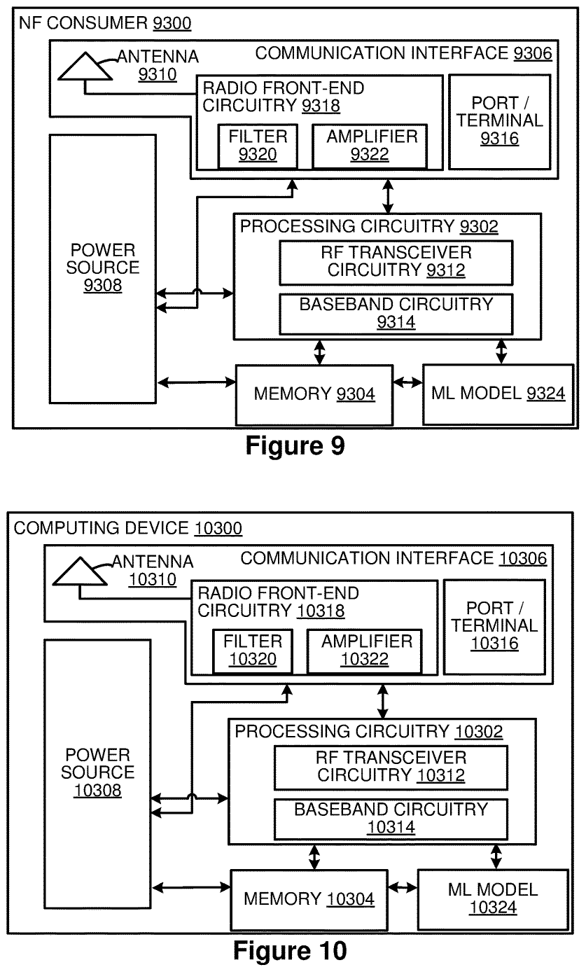

FIG. 9 shows a NF consumer 9300 (e.g., a network node) in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, core network nodes, access points (APs) (e.g., radio access points), base stations (BSs) (e.g., radio base stations, Node Bs, evolved Node Bs (eNBs) and NR NodeBs (gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The NF consumer 9300 includes a processing circuitry 9302, a memory 9304, a communication interface 9306, and a power source 9308. The NF consumer 9300 may be composed of multiple physically separate components (e.g., a NodeB component and a RNC component, or a BTS component and a BSC component, etc.), which may each have their own respective components. In certain scenarios in which the NF consumer 9300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the NF consumer 9300 may be configured to support multiple radio access technologies (RATs). In such embodiments, some components may be duplicated (e.g., separate memory 9304 for different RATs) and some components may be reused (e.g., a same antenna 9310 may be shared by different RATs). The NF consumer 9300 may also include multiple sets of the various illustrated components for different wireless technologies integrated into NF consumer 9300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within NF consumer 9300.

The processing circuitry 9302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other NF consumer 9300 components, such as the memory 9304, to provide NF consumer 9300 functionality.

In some embodiments, the processing circuitry 9302 includes a system on a chip (SOC). In some embodiments, the processing circuitry 9302 includes one or more of radio frequency (RF) transceiver circuitry 9312 and baseband processing circuitry 9314. In some embodiments, the radio frequency (RF) transceiver circuitry 9312 and the baseband processing circuitry 9314 may be on separate chips (or sets of chips), boards, or units, such as radio units and digital units. In alternative embodiments, part or all of RF transceiver circuitry 9312 and baseband processing circuitry 9314 may be on the same chip or set of chips, boards, or units.

The memory 9304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 9302. The memory 9304 may store any suitable instructions, data, or information, including a computer program, software, an application including one or more of logic, rules, code, tables, and/or other instructions capable of being executed by the processing circuitry 9302 and utilized by the NF consumer 9300. The memory 9304 may be used to store any calculations made by the processing circuitry 9302 and/or any data received via the communication interface 9306. The memory 8304 may be communicatively couple to, or contain, ML model 9324 in accordance with some embodiments. In some embodiments, the processing circuitry 9302 and memory 9304 is integrated.

The communication interface 9306 is used in wired or wireless communication of signaling and/or data between a computing device, network node, access network, and/or UE. As illustrated, the communication interface 9306 comprises port(s)/terminal(s) 9316 to send and receive data, for example to and from a network over a wired connection. The communication interface 9306 also includes radio front-end circuitry 9318 that may be coupled to, or in certain embodiments a part of, the antenna 9310. Radio front-end circuitry 9318 comprises filters 9320 and amplifiers 9322. The radio front-end circuitry 9318 may be connected to an antenna 9310 and processing circuitry 9302. The radio front-end circuitry may be configured to condition signals communicated between antenna 9310 and processing circuitry 9302. The radio front-end circuitry 9318 may receive digital data that is to be sent out to other network nodes or UEs via a wireless connection. The radio front-end circuitry 9318 may convert the digital data into a radio signal having the appropriate channel and bandwidth parameters using a combination of filters 9320 and/or amplifiers 9322. The radio signal may then be transmitted via the antenna 9310. Similarly, when receiving data, the antenna 9310 may collect radio signals which are then converted into digital data by the radio front-end circuitry 9318. The digital data may be passed to the processing circuitry 9302. In other embodiments, the communication interface may comprise different components and/or different combinations of components.

In certain alternative embodiments, the NF consumer 9300 does not include separate radio front-end circuitry 9318, instead, the processing circuitry 9302 includes radio front-end circuitry and is connected to the antenna 9310. Similarly, in some embodiments, all or some of the RF transceiver circuitry 9312 is part of the communication interface 9306. In still other embodiments, the communication interface 9306 includes one or more ports or terminals 9316, the radio front-end circuitry 9318, and the RF transceiver circuitry 9312, as part of a radio unit (not shown), and the communication interface 9306 communicates with the baseband processing circuitry 9314, which is part of a digital unit (not shown).

The antenna 9310 may include one or more antennas, or antenna arrays, configured to send and/or receive wireless signals. The antenna 9310 may be coupled to the radio front-end circuitry 9318 and may be any type of antenna capable of transmitting and receiving data and/or signals wirelessly. In certain embodiments, the antenna 9310 is separate from the NF consumer 9300 and connectable to the NF consumer 9300 through an interface or port.

The antenna 9310, communication interface 9306, and/or the processing circuitry 9302 may be configured to perform any receiving operations and/or certain obtaining operations described herein as being performed by the network node. Any information, data and/or signals may be received from a computing device, UE, another network node and/or any other network equipment. Similarly, the antenna 9310, the communication interface 9306, and/or the processing circuitry 9302 may be configured to perform any transmitting operations described herein as being performed by the network node. Any information, data and/or signals may be transmitted to a UE, another network node and/or any other network equipment.

The power source 9308 provides power to the various components of NF consumer 9300 in a form suitable for the respective components (e.g., at a voltage and current level needed for each respective component). The power source 9308 may further comprise, or be coupled to, power management circuitry to supply the components of the NF consumer 9300 with power for performing the functionality described herein. For example, the NF consumer 9300 may be connectable to an external power source (e.g., the power grid, an electricity outlet) via an input circuitry or interface such as an electrical cable, whereby the external power source supplies power to power circuitry of the power source 9308. As a further example, the power source 9308 may comprise a source of power in the form of a battery or battery pack which is connected to, or integrated in, power circuitry. The battery may provide backup power should the external power source fail.

Embodiments of the NF consumer 9300 may include additional components beyond those shown in FIG. 9 for providing certain aspects of the network node's functionality, including any of the functionality described herein and/or any functionality necessary to support the subject matter described herein. For example, the NF consumer 9300 may include user interface equipment to allow input of information into the NF consumer 9300 and to allow output of information from the NF consumer 9300. This may allow a user to perform diagnostic, maintenance, repair, and other administrative functions for the NF consumer 9300.

FIG. 10 shows a computing device (e.g., a network node) 10300 in accordance with some embodiments. An example of a network node of FIG. 10 includes NWDAF 100 (including NWDAF 400, ANLF 104, MTLF 102, NALF 402 discussed herein.

Other examples of network nodes include multiple transmission point (multi-TRP) 5G access nodes, MSR equipment such as MSR BSs, network controllers such as RNCs or BSCs, BTSs, transmission points, transmission nodes MCEs, O&M nodes, OSS nodes, SON nodes, positioning nodes (e.g., E-SMLCs), and/or MDTs.

The network node 10300 includes a processing circuitry 10302, a memory 10304, a communication interface 10306, and a power source 10308. The network node 10300 may be composed of multiple physically separate components (e.g., a NodeB component and a RNC component, or a BTS component and a BSC component, etc.), which may each have their own respective components. In certain scenarios in which the network node 10300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 10300 may be configured to support multiple RATs. In such embodiments, some components may be duplicated (e.g., separate memory 10304 for different RATs) and some components may be reused (e.g., a same antenna 10310 may be shared by different RATs). The network node 10300 may also include multiple sets of the various illustrated components for different wireless technologies integrated into network node 10300, for example GSM, WCDMA, LTE, NR, WiFi, Zigbee, Z-wave, LoRaWAN, RFID or Bluetooth wireless technologies. These wireless technologies may be integrated into the same or different chip or set of chips and other components within network node 10300.

The processing circuitry 10302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 10300 components, such as the memory 10304, to provide network node 10300 functionality.

In some embodiments, the processing circuitry 10302 includes a SOC. In some embodiments, the processing circuitry 10302 includes one or more of RF transceiver circuitry 10312 and baseband processing circuitry 10314. In some embodiments, the RF transceiver circuitry 10312 and the baseband processing circuitry 10314 may be on separate chips (or sets of chips), boards, or units, such as radio units and digital units. In alternative embodiments, part or all of RF transceiver circuitry 10312 and baseband processing circuitry 10314 may be on the same chip or set of chips, boards, or units.

The memory 10304 may comprise any form of volatile or non-volatile computer-readable memory including, without limitation, persistent storage, solid-state memory, remotely mounted memory, magnetic media, optical media, RAM, ROM) mass storage media (for example, a hard disk), removable storage media (for example, a flash drive, a CD or a DVD), and/or any other volatile or non-volatile, non-transitory device-readable and/or computer-executable memory devices that store information, data, and/or instructions that may be used by the processing circuitry 10302. The memory 10304 may store any suitable instructions, data, or information, including a computer program, software, an application including one or more of logic, rules, code, tables, and/or other instructions capable of being executed by the processing circuitry 10302 and utilized by the network node 10300. The memory 10304 may be used to store any calculations made by the processing circuitry 10302 and/or any data received via the communication interface 10306. The memory 10304 may be communicatively coupled to, or include, ML model 10324 in accordance with some embodiments discussed herein. In some embodiments, the processing circuitry 10302 and memory 10304 is integrated.

The communication interface 10306 is used in wired or wireless communication of signaling and/or data between a computing device, a NF consumer, network node, access network, and/or UE. As illustrated, the communication interface 10306 comprises port(s)/terminal(s) 10316 to send and receive data, for example to and from a network over a wired connection. The communication interface 10306 also includes radio front-end circuitry 10318 that may be coupled to, or in certain embodiments a part of, the antenna 10310. Radio front-end circuitry 10318 comprises filters 10320 and amplifiers 10322. The radio front-end circuitry 10318 may be connected to an antenna 10310 and processing circuitry 10302. The radio front-end circuitry may be configured to condition signals communicated between antenna 10310 and processing circuitry 10302. The radio front-end circuitry 10318 may receive digital data that is to be sent out to other network nodes or UEs via a wireless connection. The radio front-end circuitry 10318 may convert the digital data into a radio signal having the appropriate channel and bandwidth parameters using a combination of filters 10320 and/or amplifiers 10322. The radio signal may then be transmitted via the antenna 10310. Similarly, when receiving data, the antenna 10310 may collect radio signals which are then converted into digital data by the radio front-end circuitry 10318. The digital data may be passed to the processing circuitry 10302. In other embodiments, the communication interface may comprise different components and/or different combinations of components.

In certain alternative embodiments, the network node 10300 does not include separate radio front-end circuitry 10318, instead, the processing circuitry 10302 includes radio front-end circuitry and is connected to the antenna 10310. Similarly, in some embodiments, all or some of the RF transceiver circuitry 10312 is part of the communication interface 10306. In still other embodiments, the communication interface 10306 includes one or more ports or terminals 10316, the radio front-end circuitry 10318, and the RF transceiver circuitry 10312, as part of a radio unit (not shown), and the communication interface 10306 communicates with the baseband processing circuitry 10314, which is part of a digital unit (not shown).

The antenna 10310 may include one or more antennas, or antenna arrays, configured to send and/or receive wireless signals. The antenna 10310 may be coupled to the radio front-end circuitry 10318 and may be any type of antenna capable of transmitting and receiving data and/or signals wirelessly. In certain embodiments, the antenna 10310 is separate from the network node 10300 and connectable to the network node 10300 through an interface or port.

The antenna 10310, communication interface 10306, and/or the processing circuitry 10302 may be configured to perform any receiving operations and/or certain obtaining operations described herein as being performed by the network node. Any information, data and/or signals may be received from a UE, another network node and/or any other network equipment. Similarly, the antenna 10310, the communication interface 10306, and/or the processing circuitry 10302 may be configured to perform any transmitting operations described herein as being performed by the network node. Any information, data and/or signals may be transmitted to a UE, another network node and/or any other network equipment.

The power source 10308 provides power to the various components of network node 10300 in a form suitable for the respective components (e.g., at a voltage and current level needed for each respective component). The power source 10308 may further comprise, or be coupled to, power management circuitry to supply the components of the network node 10300 with power for performing the functionality described herein. For example, the network node 10300 may be connectable to an external power source (e.g., the power grid, an electricity outlet) via an input circuitry or interface such as an electrical cable, whereby the external power source supplies power to power circuitry of the power source 10308. As a further example, the power source 10308 may comprise a source of power in the form of a battery or battery pack which is connected to, or integrated in, power circuitry. The battery may provide backup power should the external power source fail.

Embodiments of the network node 10300 may include additional components beyond those shown in FIG. 10 for providing certain aspects of the network node's functionality, including any of the functionality described herein and/or any functionality necessary to support the subject matter described herein. For example, the network node 10300 may include user interface equipment to allow input of information into the network node 10300 and to allow output of information from the network node 10300. This may allow a user to perform diagnostic, maintenance, repair, and other administrative functions for the network node 10300.

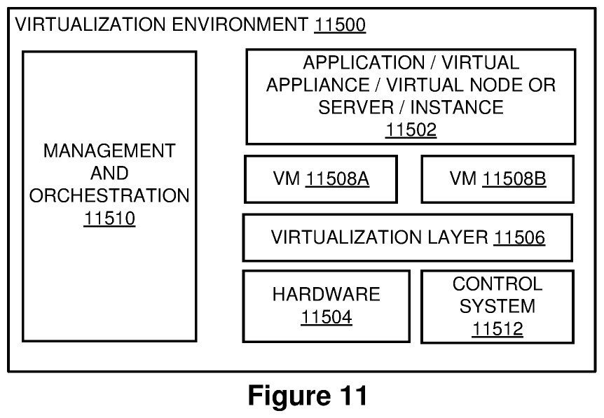

FIG. 11 is a block diagram illustrating a virtualization environment 11500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 11500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 11502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 11504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 11506 (also referred to as hypervisors or virtual machine monitors (VMMs)), provide VMs 11508a and 11508b (one or more of which may be generally referred to as VMs 11508), and/or perform any of the functions, features and/or benefits described in relation with some embodiments described herein. The virtualization layer 11506 may present a virtual operating platform that appears like networking hardware to the VMs 11508.

The VMs 11508 comprise virtual processing, virtual memory, virtual networking or interface and virtual storage, and may be run by a corresponding virtualization layer 11506. Different embodiments of the instance of a virtual appliance 11502 may be implemented on one or more of VMs 11508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 11508 may be a software implementation of a physical machine that runs programs as if they were executing on a physical, non-virtualized machine. Each of the VMs 11508, and that part of hardware 11504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 11508 on top of the hardware 11504 and corresponds to the application 11502.

Hardware 11504 may be implemented in a standalone network node with generic or specific components. Hardware 11504 may implement some functions via virtualization. Alternatively, hardware 11504 may be part of a larger cluster of hardware (e.g. such as in a data center or CPE) where many hardware nodes work together and are managed via management and orchestration 11510, which, among others, oversees lifecycle management of applications 11502. In some embodiments, hardware 11504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 11512 which may alternatively be used for communication between hardware nodes and radio units.

Although the computing devices described herein (e.g., network nodes, NF consumers, UEs, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description

1. A computer-implemented method performed by a computing device comprising a network data analytics function, NWDAF, to provide aggregated analytics from a plurality of network functions in a communication network, the method comprising:
aggregating a plurality of different analytics from the plurality of network functions to obtain an aggregated analytics, the plurality of different analytics comprising at least one of a different hierarchical level in the plurality of network functions, and/or a different timescale, a different periodicity, a common input analytic, and a common output analytic in the plurality of different analytics;
obtaining a latent space of the plurality of different analytics with a first machine learning, ML, model applied to the aggregated analytics; and
sending to at least a network function consumer at least one of the latent space and the plurality of different analytics.

2. The method of claim 1, wherein the first ML model comprises an auto-encoder.

3. The method of claim 2, wherein the obtaining comprises an output layer of an encoder of the auto-encoder comprising the latent space of the plurality of different analytics and the output layer is connected to a plurality of network function consumers, and the sending further comprises sending a decoder to a respective network function consumer from the plurality of network function consumers to decode the latent space of the plurality of different analytics.

4. The method of claim 2, wherein the obtaining comprises an output layer of an encoder of the auto-encoder comprising the latent space of the plurality of different analytics and the output layer is connected to a plurality of network function consumers, and the sending comprises sending the latent space of the plurality of different analytics to a respective network function consumer from the plurality of network function consumers to use as an input to a second ML model of the network function consumer to make a decision at the network function consumer.

5. The method of claim 2, wherein the obtaining comprises storing an output layer of an encoder of the auto-encoder comprising the latent space of the plurality of different analytics, and accessing a decoder stored at the NWDAF of the computing device, and decoding the latent space of the plurality of different analytics, and the sending comprises sending the decoded plurality of different analytics to a network function consumer.

6. The method of claim 2, wherein the aggregating comprises (i) applying clustering on the plurality of different analytics, (ii) tagging the clustered analytics via a suitable for aggregation analysis, and (iii) deciding on at least one of an input and an output parameter of the auto-encoder to enhance a reconstruction error.

7. The method of claim 6, further comprising:
training the auto-encoder with the tagged and clustered analytics, wherein the training comprises (i) training the encoder using the tagged and clustered analytics, and (ii) training a decoder of the auto-encoder on a common output of the tagged and clustered analytics.

8. The method of claim 2, the method further comprising:
storing the trained auto-encoder.

9. The method of claim 2, wherein the obtaining the latent space comprises (i) inputting the plurality of different analytics to an encoder of the auto-encoder, and (ii) outputting from the auto-encoder the latent space of the plurality of different analytics.

10. A computer-implemented method performed by a computing device comprising a network data analytics function, NWDAF, to provide aggregated analytics from a plurality of network functions in a communication network, the method comprising:
clustering a plurality of different analytics from the plurality of network functions to obtain an aggregated analytics, the plurality of different analytics comprising at least one of a different hierarchical level in the plurality of network functions, and/or a different timescale, a different periodicity, a common input analytic, and a common output analytic in the plurality of different analytics;
obtaining an exchange of at least one of a value and a policy for the plurality of different analytics with a machine learning, ML, model applied to the aggregated analytics; and
identifying an interface to relay the at least one of a value and a policy to a network function consumer comprising a network function of a higher layer or a lower layer.

11. The method of claim 10, wherein the ML model comprises a hierarchical reinforcement learning, RL, model comprising a value function or a policy.

12. The method of claim 11, wherein the plurality of different analytics is an input to the RL model and an output of the RL model comprises a value function-based combination or a policy of the plurality of different analytics.

13. The method of claim 10, further comprising:
training the RL model with or without policy feedback; and
sending the output of the trained RL model towards at least the network function consumer.

14. The method of claim 13, wherein output of the RL model is used at the plurality of different network functions to create a lower scaled value function or to support a policy.

15. A computing device configured to provide aggregated analytics from a plurality of network functions in a communication network, the computing device comprising:
processing circuitry;
memory coupled with the processing circuitry, wherein the memory includes instructions that when executed by the processing circuitry causes the computing device to perform operations comprising:
aggregate a plurality of different analytics from the plurality of different network functions to obtain an aggregated analytics, the plurality of different analytics comprising at least one of a different hierarchical level in the plurality of network functions, and/or a different timescale, a different periodicity, a common input analytic, and a common output analytic in the plurality of different analytics;
obtain a latent space of the plurality of different analytics with a first machine learning, ML, model applied to the aggregated analytics; and
send to at least a network function consumer at least one of the latent space and the plurality of different analytics.

16. The computing device of claim 15, wherein the memory includes instructions that when executed by the processing circuitry causes the computing device to perform further operations comprising a network data analytics function, NWDAF, to provide aggregated analytics from a plurality of network functions in a communication network, the method comprising:
aggregating a plurality of different analytics from the plurality of network functions to obtain an aggregated analytics, the plurality of different analytics comprising at least one of a different hierarchical level in the plurality of network functions, and/or a different timescale, a different periodicity, a common input analytic, and a common output analytic in the plurality of different analytics;
obtaining a latent space of the plurality of different analytics with a first machine learning, ML, model applied to the aggregated analytics; and
sending to at least a network function consumer at least one of the latent space and the plurality of different analytics,
wherein the first ML model comprises an auto-encoder.

17-30. (canceled)

31. The method of claim 11, further comprising:
training the RL model with or without policy feedback; and
sending the output of the trained RL model towards at least the network function consumer.

32. The method of claim 12, further comprising:
training the RL model with or without policy feedback; and
sending the output of the trained RL model towards at least the network function consumer.

33. The method of claim 7, the method further comprising:
storing the trained auto-encoder.

34. The method of claim 11, wherein the plurality of different analytics is an input to the RL model and an output of the RL model comprises a value function-based.
